(19) United States
(12) Patent Application Publication
(10) Pub. No.: US 2021/0122580 A1
(43) Pub. Date: Apr. 29, 2021

(54) WIPER FOR FORMED STEEL RECIPROCATING FLOOR SLAT

(71) Applicant: Keith Manufacturing Co., Madras, OR (US)

(72) Inventor: Loren Friend, Madras, OR (US)

(73) Assignee: Keith Manufacturing Co., Madras, OR (US)

(21) Appl. No.: 17/079,486

(22) Filed: Oct. 25, 2020

Related U.S. Application Data
(60) Provisional application No. 62/925,901, filed on Oct. 25, 2019.

(51) Int. Cl. B65G 25/06

(52) U.S. Cl. CPC B65G 25/065

(57) ABSTRACT

A narrow gap exists between all-steel floor slats in a reciprocating floor slat conveyor system. The gap is closed by a steel wiper member that is attached to one of the slats and spans the gap between slats.

### TECHNICAL FIELD

This disclosure relates to reciprocating floor slat conveyors.

### BACKGROUND

Reciprocating floor slat conveyors are well-known. They consist of a series of side-by-side floor slats that are all moved in one direction at the same time. This moves or conveys a load that rests on the floor slats. Then, a lesser number of floor slats are moved in the opposite direction, sliding underneath the load. This is commonly done in sets of three, or in other words, one third of the slats are moved in the opposite direction, in sequence, until all are returned to their initial position. Moving a lesser number of slats during the return sufficiently reduces friction between the slats and the load above, such that the load holds its position during the return. Then, the slats are moved again, all at the same time, to further carry the load, and so forth, with the sequence just described being repeated until the load is moved off the reciprocating floor slat conveyor. Systems of this kind are often installed in trailers for hauling and unloading bulk materials, although there are also many other kinds of applications, including stationary applications.

The reciprocating floor slats are commonly made from extruded aluminum. However, there is a need and market for steel floor slats in lieu of using aluminum. Steel floor slats create different design issues relative to aluminum slats. The design disclosed here was created to address the elongated, lengthwise space or “gap” between formed steel floor slats after they are installed in a reciprocating floor slat system.

### SUMMARY

The design disclosed here is intended to be used in a reciprocating floor slat conveyor system that has a plurality of reciprocating floor slats formed of steel, which is different from conventional aluminum floor slat configurations. The steel slat has a top surface upon which a load rests, opposite sides, and opposite lower edges that are angled downwardly and inwardly.

A narrow space is present between side-by-side slats in the conveyor system. A steel wiper member closes the narrow space. The wiper member comprises a strip of steel having one portion that is attached to one of the slat's lower edges. Another portion of the steel strip spans the space and has an edge that contacts an adjacent slat, thus closing the space.

### BRIEF DESCRIPTION OF THE DRAWINGS

The accompanying drawings of this disclosure are described below as follows:

FIG. 1 is a cross-sectional view of a series of side-by-side reciprocating floor slats made of formed steel with a steel wiper in the lengthwise space between vertical sides of the slats;

FIG. 2 is a cross-sectional view of one formed steel slat; and

FIG. 3 is a cross-sectional view of the steel wiper.

### DETAILED DESCRIPTION

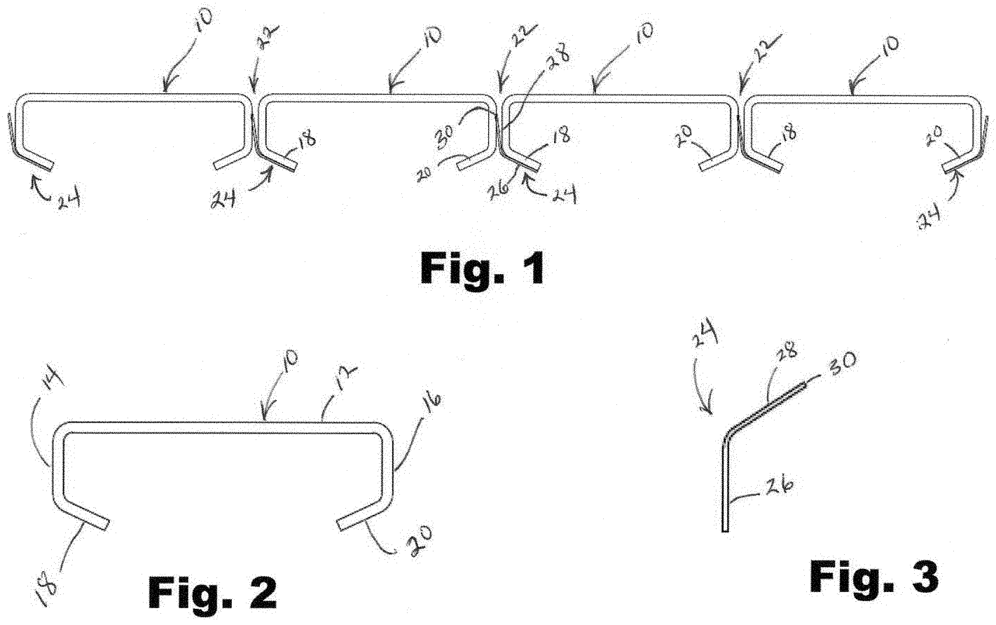

Referring now to the drawings, and first to FIG. 1, each floor slat is generally identified by reference numeral 10. For the purpose of this disclosure, it is envisioned that the floor slat 10 will be made of formed steel having the shape illustrated in the drawings. Each steel floor slat 10 is formed for use as part of a reciprocating floor slat conveyor system.

Referring now to FIG. 2, the slat 10 has a top surface 12 (upon which the load rests), opposite sides 14, 16, and opposite lower edges 18, 20 that are angled downwardly and inwardly.

As illustrated in FIG. 1, the floor slat configuration described above creates a narrow space or slot between individual floor slats 10 when the collection of slats 10 is installed as components in a reciprocating floor slat conveyor system. Reciprocating floor slat conveyors are well known. The space or slot is indicated generally at 22 in FIG. 1.

In accordance with the design disclosed here, a steel wiper (indicated generally at 24 in FIGS. 1 and 3) closes the space or slot 22 as follows: The steel wiper 24 is a bent piece or strip of steel having one portion, indicated at 26, that is attached to one of the slat's lower edges 18, as shown in FIG. 1. The attachment may be made by spot welds, as an example. Depending on slat position in the conveyor system, the steel wiper 24 could also be attached to both of the slat's lower edges 18, 20, as depicted in the right-hand most slat 10 that is illustrated in FIG. 1.

As illustrated in FIG. 1, the other portion 28 of the steel wiper 24 spans the space or slot 22 just described. Its end 30 contacts the side 16 of the next adjacent slat 10, as illustrated in FIG. 1, to close the space or slot 22.

The foregoing is not intended to place limits on patent protection. Patent protection is limited by the patent claim or claims, the interpretation of which is to be made in accordance with established doctrines of patent claim interpretation.

What is claimed is:

1. For use in a reciprocating floor slat conveyor system that has a plurality of reciprocating floor slats formed of steel, with at least one of said slats having a top surface upon which a load rests, opposite sides, and opposite lower edges that are angled downwardly and inwardly, with a narrow space between side-by-side slats in said conveyor system, and further, a steel wiper member that closes said narrow space, said wiper member comprising a strip of steel having one portion that is attached to one of said at least one slat's lower edges, and another portion of said steel strip spanning said space and having an edge that contacts an adjacent slat.
